(19) United States
(12) Patent Application Publication
(10) Pub. No.: US 2022/0042281 A1
(43) Pub. Date: Feb. 10, 2022

(54) OPERATOR PRESENCE SYSTEM

(71) Applicant: Caterpillar Inc., Peoria, IL (US)

(72) Inventors: Michael Charles Gentle, Maroa, IL (US); Ethan Michael Tevis, Bloomington, IL (US); Dustin James Funk, Dunlap, IL (US); Joshua Leigh Jordan, Germantown Hills, IL (US); Kurt William Hoch, Decatur, IL (US); Jesse Gerald Grant Fair, Monticello, IL (US)

(73) Assignee: Caterpillar Inc., Peoria, IL (US)

(21) Appl. No.: 16/984,871

(22) Filed: Aug. 4, 2020

(51) Int. Cl. E02F 9/24; B60K 28/04; E02F 9/20; B60W 10/18

(52) U.S. Cl. CPC E02F 9/24; B60K 28/04; B60W 2540/103; B60W 10/182; E02F 9/2095

(57) ABSTRACT

A work machine includes a frame; an engine supported by the frame; a plurality of ground engaging devices supporting the frame and driven by the engine; an operator cabin supported by the frame; a plurality of sensors and input devices configured to provide a plurality of signals; and a control module. The control module is configured to receive the plurality of signals from the plurality of sensors and input devices, determine if any of the plurality of signals is a positive signal, where a positive signal indicates that an operator is present in the machine, indicate an ‘operator present’ status if at least one of the plurality of signals remains positive for a debounce time, and indicate a ‘no operator present’ status if none of the plurality of signals remains positive for a threshold time.

### TECHNICAL FIELD

The present disclosure relates generally to work machines and, more specifically, relates to operator presence systems of work machines.

### BACKGROUND

Heavy duty work machines are used for innumerable purposes across many industries and applications. Such machines include construction machines such as motor graders, excavators, and bulldozers, farm equipment such as tractors and combines, mining equipment, cement trucks, dump trucks, garbage trucks, and the like. In each case, it is desirable to know if an operator is present to ensure safe operation of the machine. For example, in order for the machine to move or for many or all of the machine features to operate, an operate must be deemed present. If none is detected, many known systems engage safety features such as brakes or lockouts of some functions when no operator is present. Such interlocks and safety brakes are designed to prevent unintentional motion due to inadvertent actuation of controls or when an operator forgets to set the parking brake. In order to do so, many current operator presence systems utilize specific sensors which have no additional purpose and thus inordinately increase cost, or which require the operator to be present in a single position in order to be effective.

One example of prior art in this regard is found in U.S. Pat. No. 7,899,597 to Vitale et al. which discloses an operator presence system wherein a plurality of indicators are used to determine operator presence. In the system of Vitale, the status of a seat switch, location of an inching pedal, gear status, and machine speed are used in combination to determine operator presence and enable or disable function of a machine in response. There is a need for a work machine operator presence system which does not require dedicated single person sensors such as expensive seat switches and which takes additional factors into consideration so as not to require the operator to be in a single predetermined position in order to be deemed present.

### SUMMARY OF THE DISCLOSURE

According to one aspect of the present disclosure, a work machine is disclosed. The work machine includes a frame; an engine supported by the frame; a plurality of ground engaging devices supporting the frame and driven by the engine; an operator cabin supported by the frame; a plurality of sensors and input devices configured to provide a plurality of signals; and a control module. The control module is configured to receive the plurality of signals from the plurality of sensors and input devices, determine if any of the plurality of signals is a positive signal, where a positive signal indicates that an operator is present in the machine, indicate an ‘operator present’ status if at least one of the plurality of signals remains positive for a debounce time, and indicate a ‘no operator present’ status if none of the plurality of signals remains positive for a threshold time.

According to another aspect of the present disclosure, an operator station operator presence system is disclosed. The system includes a plurality of sensors and input devices configured to provide a plurality of signals and a control module. The control module is configured to receive the plurality of signals from the plurality of sensors and input devices, determine if any of the plurality of signals is a positive signal, where a positive signal indicates that an operator is present in the operator station, indicate an ‘operator present’ status if at least one of the plurality of signals remains positive for a debounce time, and indicate a ‘no operator present’ status if none of the plurality of signals remains positive for a threshold time.

According to yet another aspect of the present disclosure, a method of operating a work machine is disclosed. The method comprises receiving a plurality of signals indicative of operator presence; determining if any of the plurality of signals is a positive signal, where a positive signal indicates that an operator is present in the machine; indicating an ‘operator present’ status if at least one of the plurality of signals remains positive for a debounce time; and indicating a ‘no operator present’ status if none of the plurality of signals remains positive for a threshold time.

These and other aspects and features of the present disclosure will be more readily understood after reading the following detailed description in conjunction with the accompanying drawings.

### BRIEF DESCRIPTION OF THE DRAWINGS

FIG. 1 is a side-view of one embodiment of a work machine including an operator presence system according to the present disclosure.

FIG. 2 is a close up of the operator cab of FIG. 1, according to the present disclosure.

FIG. 3 is a block diagram of an operator presence system according to one aspect of the present disclosure.

FIG. 4 is a flowchart representation of a method of providing an operator presence system according to one aspect of the present disclosure.

### DETAILED DESCRIPTION

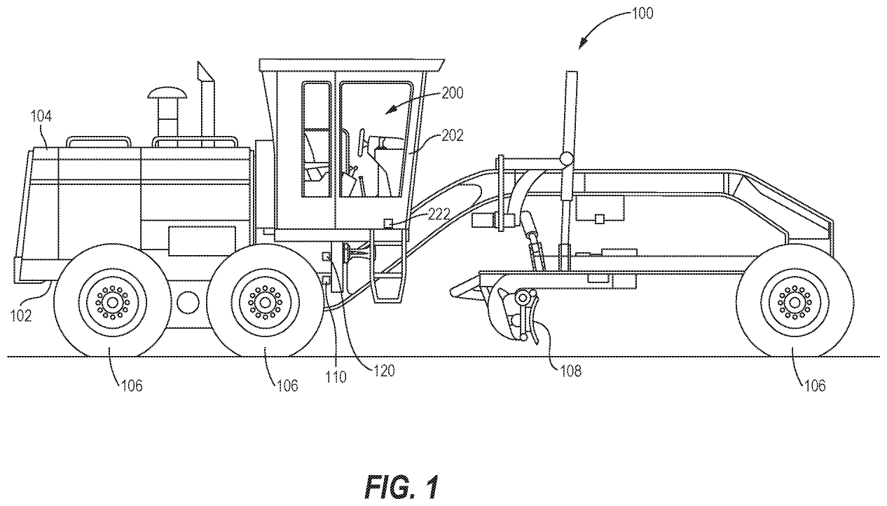

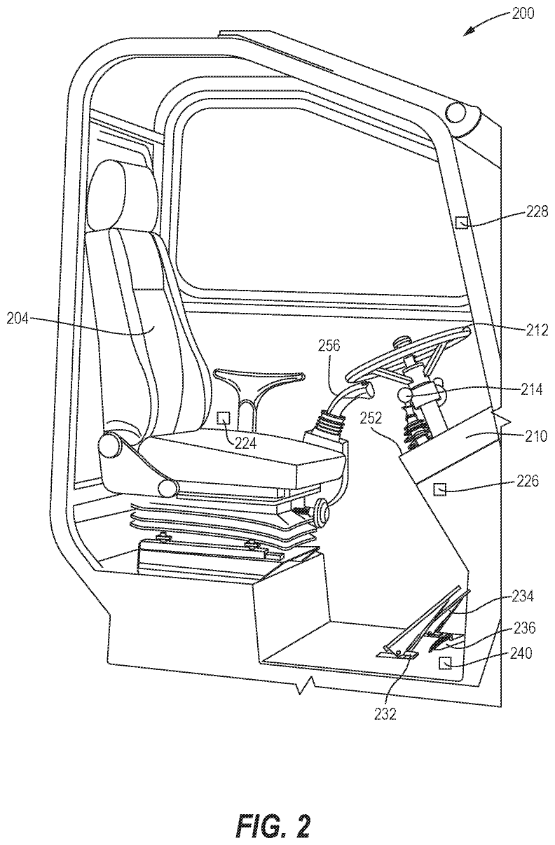

Referring now to the drawings, and with specific reference to FIG. 1, a work machine in accordance with the present disclosure is generally referred to by reference numeral 100. The work machine 100 may be any one of a number of different earth moving, construction, agricultural or industrial type machines such as a motor grader, a large mining truck, a bulldozer, an excavator, a tractor, or the like. Using the specific motor grader shown in FIG. 1 only as an example, the work machine 100 includes a frame 102, an engine 104 mounted to the frame 102, an operator cab 200 (see FIG. 2 for detailed view) supported by the frame 102, and at least one ground engaging device 106 that supports the frame 102 and is powered by the engine 104. The ground engaging device 106 may be wheels, tracks, treads, or the like which serve to enable the machine 100 to engage the ground and move. The machine 100 may additionally have various implements 108 attached to allow the machine 100 to perform various jobs. The illustrated machine 100 depicts is equipped with a blade 108; however, this implement is unique to a motor grader and many other implements on many other work machines are possible. Other work machines may also include more than one implement.

The machine 100 may also be equipped with a brake system 110. The brake system may include a service brake 112 and a parking brake 114. Additionally, the machine 100 may include a transmission system including a neutral gear and one or more forward and reverse speeds. Further, the machine 100 may have a default all-wheel-drive (AWD) system, with an option of enabling a creep mode in which only the front wheels are driven.

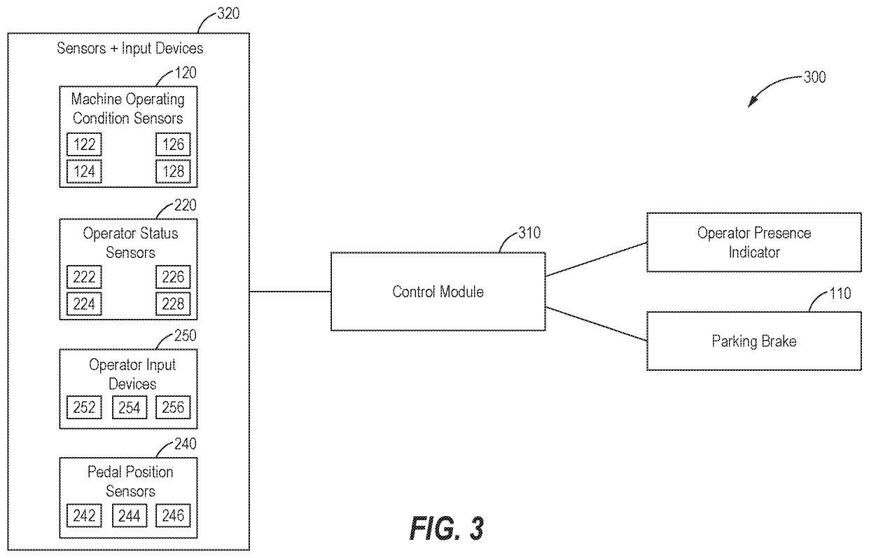

The work machine 100 may also include a plurality of machine operating condition sensors 120 (also shown in FIG. 3) configured to sense various operating conditions including, but not limited to, the actual machine speed 122, the actual engine speed 124 (usually measured by transmission output speed), the actual gear of the transmission system 126, and which AWD mode is enabled 128. As will be explained in further detail below, these machine operating condition sensors 120 may be further configured to provide a signal to a control module 310 (see FIG. 3).

The work machine 100 is controlled by an operator (not shown) from the operator cab 200, shown in more detail in FIG. 2. The operator cab 200 may have a cab door 202. A seat 204 for the operator is located in the operator cab 200 and equipped with a seat belt. A steering column 210 may include a steering wheel 212 and implement control levers 214. The steering column 210 may be adjustable from a neutral position to be more accessible for the operator.

The work machine 100 also includes a plurality of operator status sensors 220, also shown in FIG. 3. The cab door 202 (not shown) may have a sensor 222 configured to determine if the door is open or closed. The seat belt may have a sensor 224 configured to determine if the seat belt is engaged. A sensor 226 may determine the position of the steering column 210. The operator cab 200 may also include sensors 228 configured to directly detect the presence of an operator. These operator detection sensors 220 may use various technologies known in the art, including but not limited to thermal detection, face detection, eye detection, or body detection. Each of these operator status sensors 220 may be configured to provide a signal to the control module 310.

The operator cab 200 also includes various levers and pedals 230 which allow the operator to control the machine 100 and its implements 108. A throttle pedal 232 is used to control engine speed. An inching pedal 234 disengages power to the wheels 106 and allows for fine movement control. A service brake pedal 236 applies the service brakes 112. Pedal position sensors 240 for each of the throttle pedal 252, inching pedal 254, and service brake pedal 246 may be configured to sense the position of each pedal and provide a signal to the control module 310.

Other operator input devices 250 may be located on a control panel 252, or elsewhere in the operator cab 200. These may include calibration tools 254 for any machine or implement controls, park request devices 256 such as a parking brake switch or lever, and any operator selectable switches 258. Each of these operator input devices may be configured to provide a signal to the control module 310.

The machine 100 also includes an operator presence system 300. As depicted in FIG. 3, the operator presence system 300 comprises a control module 310 and a plurality of sensors and input devices 320 including, but not limited to, the machine operating condition sensors 120, operator status sensors 220, pedal positions sensors 240, and operator input devices 250 previously described. Each of the plurality of sensors and input devices 320 produces a signal which may indicate the presence of an operator in the operator cab 200 of the machine 100. If the signal indicates the presence of an operator in the operator cab 200 of the machine 100, that signal is hereafter referred to as a positive signal. Some examples of positives signals include, but are not limited to: the actual gear is not neutral; the actual machine speed is greater than zero; the actual engine speed is greater than a threshold speed; the AWD system is in creep mode; the throttle pedal 232 is pressed past a threshold point the inching pedal 234 is pressed past a threshold point; the service brake pedal 236 is pressed past a threshold point; the steering column 210 is moved from a neutral position; the cab door 202 is closed; the seat belt is engaged; an operator thermal output is detected; an operator face, body, or eye is detected; any calibration 254 is active, any operator park request 256 is engaged, an operator selectable switch 258 is engaged. In some embodiments, the threshold point for a pedal position may be 10% of the pedal travel range. The threshold actual engine speed is dependent on the specific machine and engine to which the system is applied but may be a low idle speed plus a small buffer. Other thresholds may be used as particular applications demand. Other signals which indicate the presence of an operator may additionally be included in the system.

The control module 310 is configured to receive the plurality of signals from the plurality of sensors and input devices 320. The control module 310 then determines if any of the plurality of signals is a positive signal. If at least one of the plurality of signals is remains positive for a debounce time, the control module 310 will indicate an ‘Operator Present’ status. In order to avoid faulty signals triggering the status in error, the system may require that the positive signal remain positive for a short debounce time prior to indicating an ‘Operator Present’ status. The debounce time may be 1 to 30 seconds, but of course other durations are possible. In some embodiments, at least two positive signals may be required before an ‘Operator Present’ status is indicated. In some embodiments requiring two positive signals, a first positive signal and a second positive signal may be selected from different sets of inputs

On the other hand, the control module 310 will indicate a ‘No Operator Present’ status if none of the signals are positive for a threshold time. If a ‘No Operator Present’ status is indicated, the control module 310 may disable the machine 100 by engaging the parking brake 114. The threshold time may reduce nuisance “not present” detection caused by temporary changes in the operator's actions, as associated with prior art devices. For example, if an operator comes to a stop on a construction site and takes his or her foot off a pedal, the threshold time prevents the system from immediately setting the parking brake 114. In some embodiments, the threshold time may be between 10 and 30 seconds. In some other embodiments, the threshold time may be between 15 and 20 seconds. Of course, other longer or shorter times may be used as demanded by a particular application or signal type. In some embodiments, additional methods of disabling the machine 100 may also be implemented, including, but not limited to, locking steering controls, locking implement controls, and other similar technologies known in the art.

If an ‘Operator Present’ is indicated, the control module 310 may enable operation of the work machine 100 if disabled. This enablement may include allowing disengagement of the parking brake 114 and removing any lockouts of implements 108 and controls.

### INDUSTRIAL APPLICABILITY

In operation, the operator presence system 200 of the present disclosure would be useful in a variety of industrial applications, such as, but not limited to, any application in which an operator is required to be present for safe operation of a heavy duty vehicle. Such applications may include construction and mining vehicles such as motor graders, mining trucks, bulldozers, excavators, or tractors. In each case, it is desirable to know if an operator is present to ensure safe operation of the machine. For example, in order for the machine to move or for many or all of the machine features to operate, an operate must be deemed present. If none is detected, many known systems engage safety features such as brakes or lockouts of some functions when no operator is present. Such interlocks and safety brakes are designed to prevent unintentional motion due to inadvertent actuation of controls or when an operator forgets to set the parking brake. In order to do so, many current operator presence systems utilize specific sensors which have no additional purpose and thus inordinately increase cost, or which require the operator to be present in a single position in order to be effective.

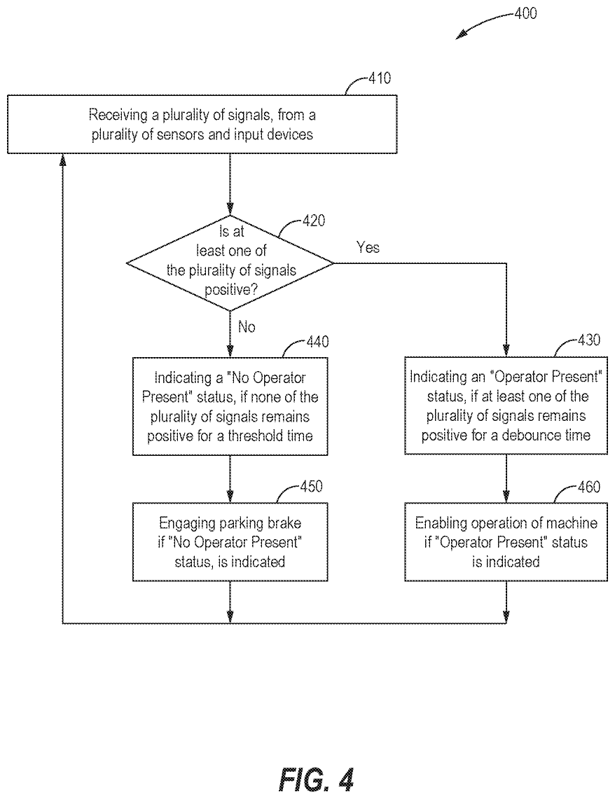

The operator presence system 300 may be put into effect by a method 400 described in FIG. 4. The method 400 may begin as shown in block 410 by receiving a plurality of signals from the plurality of sensors and input devices 320. The plurality of sensors and input devices 320 may include pedal position sensors 240, machine operating condition sensors 120, operator-controlled input devices 250, or operator cab sensors 220, as previously described.

Next, it is determined whether any of the plurality of signals is positive (decision 420). A positive signal is one which indicates an operator is present in the operator cab 200 of the machine 100. If at least one of the plurality of signals remains positive for a debounce time, a ‘Operator Present’ status is indicated, per block 430. As noted above, the debounce time may be between 1 and 30 seconds, but other times are possible. In some embodiments, at least two positive signals may be required before an ‘Operator Present’ status is indicated. On the other hand, if none of the plurality of signals is positive for a threshold time, a ‘No Operator Present’ status is indicated, as shown in block 440. The threshold time may be between 10 and 30 seconds, although other times are of course possible.

If a ‘No Operator Present’ is indicated, the method may conclude by engaging the parking brake 114 (block 450) and resetting back to the receiving step 410 for further monitoring. In some embodiments, additional methods of disabling the work machine 100 may also be implemented, including, but not limited to, locking steering controls, locking implement controls, and other similar means known in the art.

If an ‘Operator Present’ is indicated, the method may instead conclude by enabling operation of the work machine 100 if disabled, as shown in block 460, and resetting back to the receiving step 410 for further monitoring. This enablement may include allowing disengagement of the parking brake 114 and removing any lockouts of implements and controls.

While the preceding text sets forth a detailed description of numerous different embodiments, is should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A work machine, comprising:
a frame;
an engine supported by the frame;
a plurality of ground engaging devices supporting the frame and driven by the engine;
an operator cab supported by the frame;
a plurality of sensors and input devices configured to provide a plurality of signals; and
a control module configured to:
receive the plurality of signals from the plurality of sensors and input devices,
determine if any of the plurality of signals is a positive signal, where a positive signal indicates that an operator is present in the operator cab,
indicate an ‘operator present’ status if at least one of the plurality of signals remains positive for a debounce time, and
indicate a ‘no operator present’ status if none of the plurality of signals remains positive for a threshold time.

2. The machine of claim 1, wherein the control module is configured to indicate an ‘operator present’ status if at least two of the plurality of signals remain positive for a debounce time.

3. The machine of claim 1, wherein the threshold time is between 10 and 30 seconds.

4. The machine of claim 1, wherein the control module is further configured to engage a parking brake if the ‘no operator present’ status is indicated.

5. The machine of claim 1, wherein the plurality of sensors and input devices includes pedal position sensors, machine operating condition sensors, operator-controlled input devices, or operator cab sensors.

6. An operator cab operator presence system of detecting an operator, comprising:
a plurality of sensors and input devices configured to provide a plurality of signals; and
a control module configured to:
receive the plurality of signals from the plurality of sensors and input devices,
determine if any of the plurality of signals is a positive signal, where a positive signal indicates that an operator is present in the operator cab,
indicate an ‘operator present’ status if at least one of the plurality of signals remains positive for a debounce time, and
indicate a ‘no operator present’ status if none of the plurality of signals remains positive for a threshold time.

7. The system of claim 6, wherein the control module is configured to indicate an ‘operator present’ status if at least two of the plurality of signals remain positive for a debounce time.

8. The system of claim 6, wherein the threshold time is between 10 and 30 seconds.

9. The system of claim 6, wherein the control module is further configured to engage a parking brake if the ‘no operator present’ status is indicated.

10. The system of claim 6, wherein the plurality of sensors and input devices include pedal position sensors.

11. The system of claim 6, wherein the plurality of sensors and input devices include machine operating condition sensors.

12. The system of claim 6, wherein the plurality of sensors and input devices include operator-controlled input devices.

13. The system of claim 6, wherein the plurality of sensors and input devices include operator cab sensors.

14. A method of operating a work machine, comprising:
receiving a plurality of signals indicative of operator presence;
determining if any of the plurality of signals is a positive signal, where a positive signal indicates that an operator is present in the work machine;
indicating an ‘operator present’ status if at least one of the plurality of signals remains positive for a debounce time; and
indicating a ‘no operator present’ status if none of the plurality of signals remains positive for a threshold time.

15. The method of claim 14, wherein indicating an ‘operator present’ status requires at least two of the plurality of signals remain positive for a debounce time.

16. The method of claim 14, wherein the threshold time is between 10 and 30 seconds.

17. The method of claim 14, further comprising engaging a parking brake if the ‘no operator present’ status is indicated.

18. The method of claim 14, wherein the plurality of sensors and input devices include pedal position sensors.

19. The method of claim 14, wherein the plurality of sensors and input devices include machine operating condition sensors.

20. The method of claim 14, wherein the plurality of sensors and input devices include operator-controlled input devices.
